(19) United States
(12) Patent Application Publication
(10) Pub. No.: US 2003/0068412 A1
(43) Pub. Date: Apr. 10, 2003

(54) Gyro pop

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 09/971,592

(22) Filed: Oct. 9, 2001

(51) Int. Cl. A23G 1/00

(52) U.S. Cl. 426/134

(57) ABSTRACT

A gyro pop including a housing with a rotatable weighted circular disk therein. The rotatable circular disk is pivoted on two pivot points and driven by a driven gear which is activated by a rod gear when the rod gear is forced in one direction and then withdrawn quickly in order to drive the driven gear. The rotatable circular disk may carry a power supply, a motion switch, a circuit board, and integrated circuit which activates a plurality of LED lights in a random order. A lollipop is supported by the housing and can be consumed while the rotatable circular disk rotates. During rotation of the rotatable circular disk the motion switch activated the integrated circuit which activated the LEDs.

### BACKGROUND OF THE INVENTION

This invention relates to a Disclosure Document deposited in the U.S. Patent and Trademark Office on Nov. 13, 2000.

This invention sets forth a candy holding device including motion and lights in combination with a piece of candy such as a lollipop. More particularly this invention is directed to a gyro pop which provides persons such as children many hours of fun.

### SUMMARY OF THE INVENTION

An object of the invention is to provide a fun device which is different from other fun devices.

Another object is to provide a fun device which can be enjoyed by a plurality of different aged persons.

Yet another object is to provide a mechanically operated device which is easily operated by different aged persons.

An advantage of the device is the simple manner in which it is operated.

Another advantage is to provide a device which may be operated in different modes of operation.

Other objects and advantages of the invention will become obvious to those skilled in the art upon a review of the drawings, specification and claims.

### BRIEF DESCRIPTION OF THE DRAWINGS

FIG. 1 is a side view illustrating the relationship of the different parts;

FIG. 2 illustrates a detachable handle by which the handle can be removed so that the device can be used as a spinning top;

FIG. 3 illustrates an integrated circuitry for operating different diode lights; and

FIG. 4 illustrates a modification using a trigger mechanism.

### DETAILED DESCRIPTION OF THE INVENTION

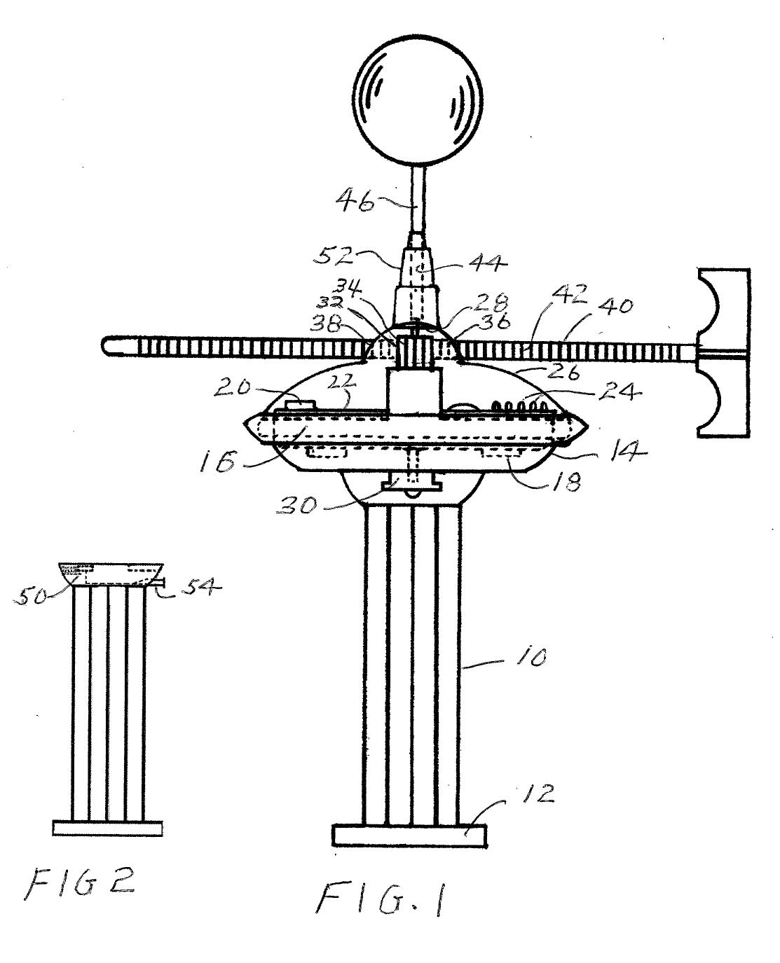

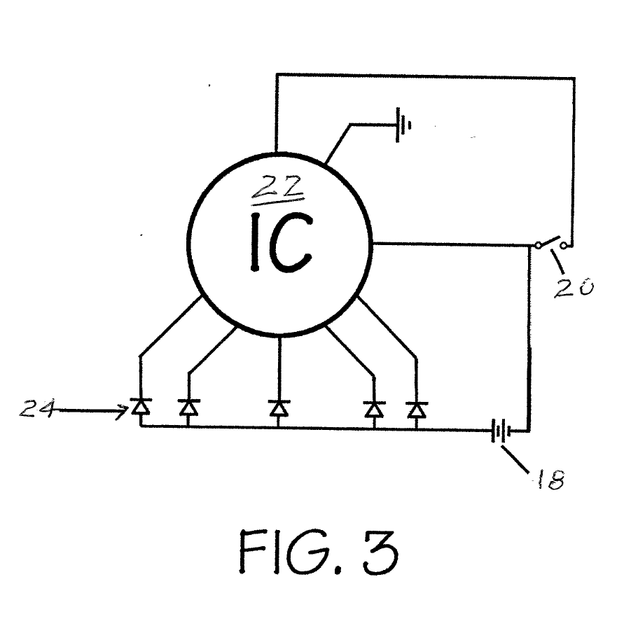

Now referring to the drawings wherein the same parts shown are to be referred to by the same reference characters, FIG. 1 illustrates a side view which illustrates the cooperation of the different parts. The device includes a handle 10 having a base 12. A main housing 14 is supported on a handle and includes therein a balanced weighted circular disk 16 to which a power supply 18 is secured, an electrical motion switch 20, an integrated circuit board 22 and a plurality of LED lights 24. The housing is enclosed by an upper dome 26 which also serves as an upper pivot point 28 for the balanced weighted circular disk. A lower pivot point 30 is provided for supporting the balanced weighted circular disk. The removable transparent dome can be secured to the main housing by any well-known manner obvious to one skilled in the art. The upper pivot end of the disk is provided with a driven gear 32 having spaced teeth 34 thereon. In order to rotate the balanced weighted circular disk the upper dome is provided with oppositely disposed slots 36, 38 through which an elongated toothed drive rod 40 passes. The teeth 42 on the rod 40 mate with the teeth 34 of the driven gear in order to rotate the balanced weighted circular disk. The upper removable transparent dome has a candy stick holder 52 secured thereto and extending upwardly therefrom. The candy stick holder is provided with an aperture 44 which receives one end 46 of the candy stick for supporting a candy pop on the candy stick. The candy pop may be molded onto the candy stick holder.

In operation of the device, a person passes the drive rod 40 through the slots in the removable dome in order to engage the teeth on the driven gear. The drive rod 40 is pushed in as far as desired. The further the rod is passed into the dome, the more turns the balanced weighted circular disk will rotate. When the drive gear rod is pulled completely from the dome with a quick pull, the driven gear 32 will rotate the balanced weighted circular disk. As the weighted disk rotates, the motion switch will close and the integrated circuit which is loaded with different signals to randomly turn the LED lights off and on creates different light patterns. By pulling the drive rod out of the dome completely with a quick pull, the device can be held in the person's hand. While eating the candy the person will feel a motion produced by the weighted disk and will also see the different patterns of light from the LEDs.

As shown in FIG. 2, the handle can be provided with spring-loaded pins 50 by which the handle can be secured to the main housing for removal of the handle. The handle can be removed and then the drive rod can be passed into the dome in preparation for driving the driven gear. The drive rod gear can be withdrawn to rotate the driven gear and the circular disk. After removing the drive rod with a quick pull and with the handle removed, the device can be placed on a hard surface and the device will rotate such as a spinning top.

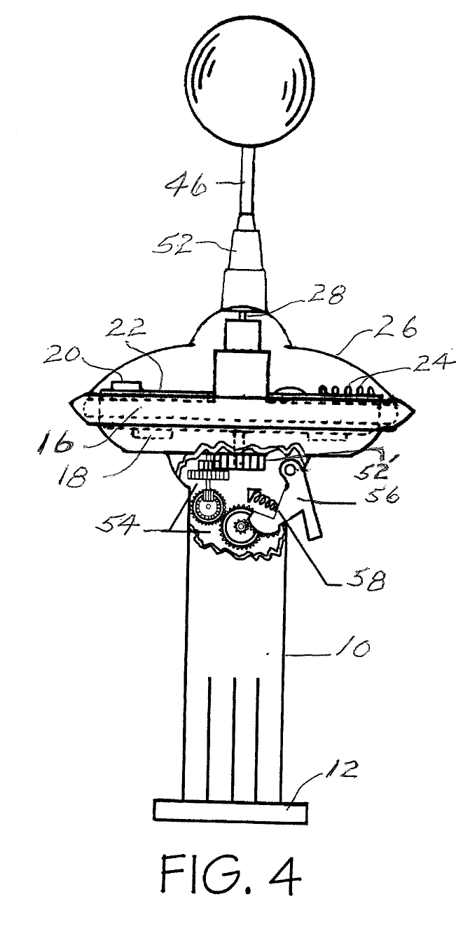

FIG. 4 illustrates a different mechanism for rotating the weighted disk. The driven gear 52 is secured to the lower pivot pin of the circular disk and a gear assembly 54 is driven by a geared trigger 56 which is spring loaded by a return spring 58. In operation, the geared trigger is pushed in to rotate the gear assembly and the driven gear 52. The geared trigger can be pressed in more than once in order to drive the driven gear faster. The modification shown in FIG. 4 does not require a rod gear such as shown for the drive of FIG. 1.

With either drive mechanism, the device can provide a lot of amusement for a child.

The housing handle and dome is shown made of transparent plastic. Obviously the parts must be made with smooth edges so that a user will not injure themselves while using the device.

The foregoing relates to preferred exemplary embodiments of the invention, it being understood that other variants and embodiments thereof are possible within the spirit and scope of the invention, the latter being defined by the appended claims.

We claim:

1. A gyro pop which comprises a housing,
a balanced weighted circular disk which is pivoted on two axially spaced pivots,
a driven gear that rotates the balanced weighted circular disk, and
a gear means which drives the driven gear.

2. A gyro pop as set forth in claim 1 which includes a candy holder to which a piece of candy is secured.

3. A gyro pop as set forth in claim 2, in which a piece of candy is molded to said candy holder.

4. A gyro pop as set forth in claim 2, in which said candy holder includes a candy stick receptacle, and
said piece of candy is supported on a candy stick which is held in said receptacle.

5. A gyro pop as set forth in claim 3, in which said driven gear is driven by a rod which is operated relative to said driven gear.

6. A gyro pop as set forth in claim 4, in which said driven gear is driven by a rod which is operated relative to said driven gear.

7. A gyro pop as set forth in claim 3, in which said driven gear is driven by a geared trigger in combination with a plurality of gears which drive said driven gear.

8. A gyro pop as set forth in claim 4, in which said driven gear is driven by a geared trigger in combination with a plurality of gears which drive said driven gear.

9. A gyro pop as set forth in claim 1, in which said housing is supported by a handle.

10. A gyro pop as set forth in claim 9, in which said housing includes a main housing portion and a removable transparent portion.

11. A gyro pop as set forth in claim 9, in which said handle is removable.

12. A gyro pop as set forth in claim 10, in which said handle is removable.

13. A gyro pop as set forth in claim 1, in which said housing includes a power supply, a motion switch, and an integrated circuit which activates a plurality of LEDs in a random order.

14. A gyro pop as set forth in claim 7, in which said housing includes a power supply, a motion switch, and an integrated circuit which activates a plurality of LEDs in a random order.
